(19) United States
(12) Patent Application Publication
(10) Pub. No.: US 2014/0025504 A1
(43) Pub. Date: Jan. 23, 2014

(54) METHOD, APPARATUS AND SYSTEM FOR INTERACTING WITH DISPLAYS USING NEAR FIELD COMMUNICATION NFC

(71) Applicants: Reid Butler, Walnut Creek, CA (US); Gregory Charles Herlein, San Francisco, CA (US)

(72) Inventors: Reid Butler, Walnut Creek, CA (US); Gregory Charles Herlein, San Francisco, CA (US)

(73) Assignee: Thomson Licensing, Issy de Moulineaux (FR)

(21) Appl. No.: 14/111,375

(22) PCT Filed: Jan. 20, 2012
(86) PCT No.: PCT/US12/21945

§ 371 Date: Oct. 11, 2013

Related U.S. Application Data
(60) Provisional application No. 61/496,359, filed on Jun. 13, 2011.

(51) Int. Cl. G06Q 30/02

(52) U.S. Cl. CPC G06Q 30/0267
USPC 705/14.64

(57) ABSTRACT

A method, apparatus and system for interacting with media screens using near field communications includes determining an identity of a near-field communication enabled mobile communications device in proximity to a display device, the display device including near-field communication capabilities and selecting content to communicate to the display device based on the determined identity of the near-field communication enabled mobile communications device. In one case, selecting content to communicate to the display device includes displaying an alternate segment of content then what was scheduled to be presented on the display device.

### FIELD OF THE INVENTION

The present invention generally relates to near field communications and, more particularly, to a method, apparatus and system for interacting with displays using near field communications.

### BACKGROUND OF THE INVENTION

Many screens providing digital advertising lack compelling means for users or operators to interact with the displays and/or content on the displays. Some screens have touch screens and thus provide programmatic means to interact (see issued patents U.S. Pat. No. 07,024,453 and U.S. Pat. No. 06,539,417), however providing/receiving information via touch screens can be cumbersome and time consuming. New near field communications (NFC) technology offers a potential for compelling new interactions. Those who program the media would like a means to uniquely identify the viewer and a viewer would like an easy means to ask for more information about the media (or the product displayed in the media). Viewers are distrustful of providing personal information on a public system, however, sharing information via their trusted mobile device seems less troublesome for most.

### SUMMARY OF THE INVENTION

Embodiments of the present invention address the deficiencies of the prior art by providing a method, apparatus and system for interacting with displays using near field communications.

In an embodiment of the present invention an NFC chip is encapsulated in a digital screen or other associated media devices. In an out-of-home advertising application, NFC communications enables a user, such as a shopper, to interact with the screen to identify themselves and to obtain more information about a product on display (or alternate products of interest). In an in-home application, NFC interaction can identify users of the digital screen or media devices.

In yet an alternate embodiment of the present invention, an operator can communicate with a display using NFC communication for purposes of, for example, configuring the display or receiving information regarding the status of the display.

In one embodiment of the present invention, a method for interacting with content on a display device using near-field communication (NFC) includes determining an identity of a NFC-enabled mobile communications device in proximity to the display device, the display device including near-field communication capabilities and selecting content to communicate to the display device based on the determined identity of the NFC-enabled mobile communications device.

In an alternate embodiment of the present invention, an apparatus for interacting with content on a display device using near-field communication (NFC) includes a memory for storing program routines and data and a processor for executing the program routines. The processor of the apparatus, when executing the program routines is configured to perform the steps of determining an identity of a NFC-enabled mobile communications device in proximity to the display device, the display device including near-field communication capabilities and selecting content to communicate to the display device based on the determined identity of the NFC-enabled mobile communications device.

In an alternate embodiment of the present invention, a system for enabling interaction with content on a display device includes at least one content source for providing media content, an apparatus including a memory for storing program routines and data, and a processor for executing said program routines and a display for displaying at least one of selected content and data related to the selected content. In the above described embodiment, the processor, when executing the program routines is configured to perform the steps of determining an identity of a near-field communication enabled mobile communications device in proximity to the display device, the display device including near-field communication capabilities and selecting content to communicate to the display device based on the determined identity of the near-field communication enabled mobile communications device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising in which an embodiment of the present invention can be applied;

FIG. 3 depicts a sequence diagram of user interaction with media on a display using near field communication in accordance with an embodiment of the present invention; and

FIG. 4 depicts a sequence diagram of the display of media related to a product display on a mobile device display in accordance with an alternate embodiment of the present invention; and

FIG. 5 depicts a flow diagram of a method for using near field communication for interacting with a display in accordance with an embodiment of the present invention; and

FIG. 6 depicts a high-level block diagram of a media decision engine/module in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for interacting with display using near field communications. Although the present invention will be described primarily within the context of an in-store retail advertising network environment and consumer communication with media on screens, the specific embodiments of the present invention should not be treated as limiting the scope of the invention. It will be appreciated by those skilled in the art and informed by the teachings of the present invention that the concepts of the present invention can be advantageously applied to any content distribution or communications network utilizing screens or displays to display media content, such as video-on-demand systems and the like and for operators to communicate with displays.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

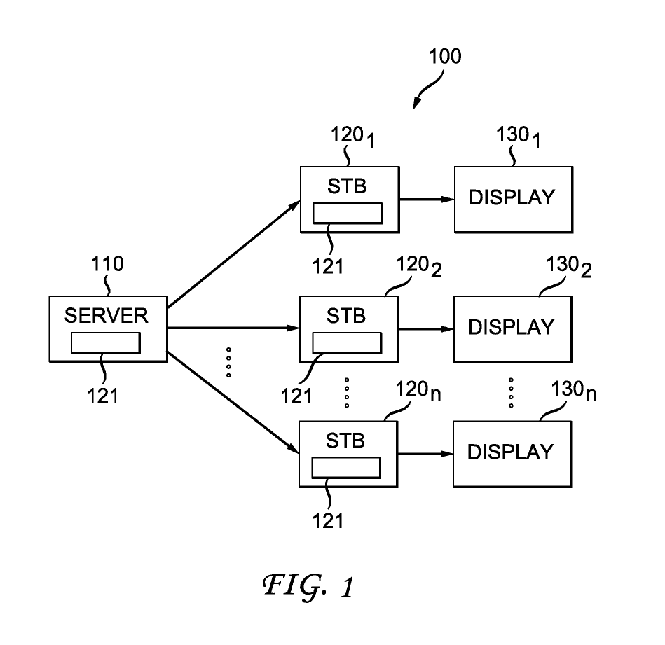

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

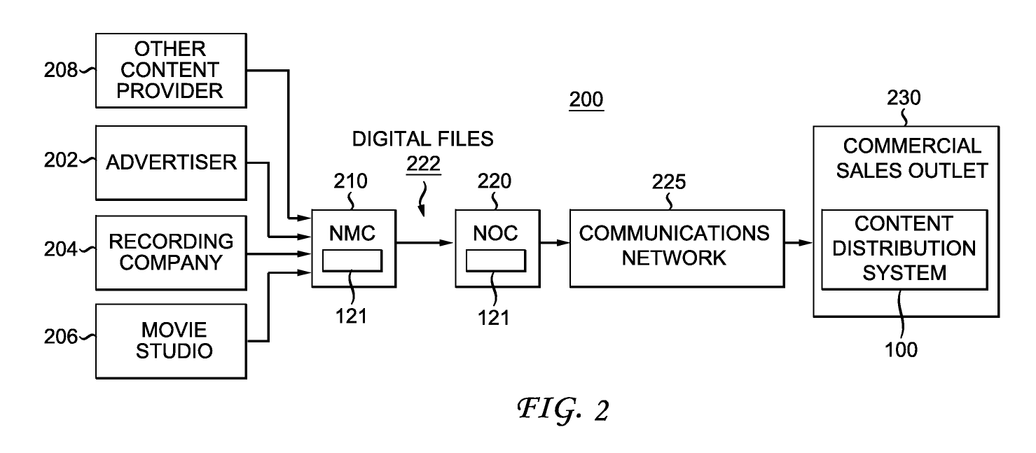

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

The various embodiments of the present invention provide a method and system for interacting with displays, such as media screens, using near field communications. In various embodiments of the present invention, an NFC chip is integrated into a display, such as the display 130 of system 100. In addition, a user can take advantage of a like chip built into and enabled in a mobile device, such as a mobile phone or other portable mobile device, to communicate with the NFC chip integrated into the display using near field communications.

For example, in the content distribution system 100 of FIG. 1, the NFC chip is integrated into the display 130 such that the data exchanged between the display 130 and a user's mobile device (not shown) is dependent on the identification of the user. This integration may be at an electronics level directly with the chip or may be accomplished using a low bit-rate serial scheme that can be communicated to the media player, such as the set-top box 125, over an HDMI CEO line. In various embodiments of the present invention, information regarding user preferences associated with respective user identification is stored at a central location, such as the server 110 of FIG. 1 or the NMC 210 or NOC 220 of the system of FIG. 2. As such, when a particular user is identified, the user preferences are referred to for deciding what particular data to present and where and how to present the data in response to user interaction.

In one embodiment of the present invention, a user of a mobile phone (or other NFC enabled mobile communications device) views content, such as an advertisement, playing on a display and decides to interact with the content. The user then places their NFC-enabled device in close proximity to the NFC active area of the display, which, in one embodiment, would be marked as such to enable easy viewer identification of where to place the mobile device. The user of the mobile device is then identified to the display and, in one embodiment, subsequently to the advertising system, for example, by providing their email address or other unique means to identify the user such as an NFC id. The content distribution system 100 then takes actions based on that identification, which, in one embodiment, might be as simple as showing a specific, directed advertisement.

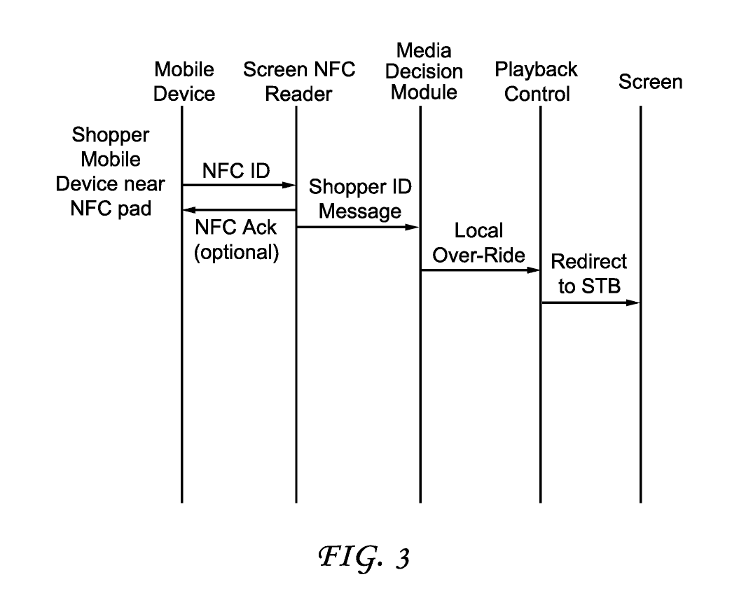

For example, FIG. 3 depicts a sequence diagram of user interaction with media on a display using near field communication in accordance with an embodiment of the present invention. As depicted in FIG. 3, a user (e.g., shopper) places an NFC-enabled device near the NFC pad of the display. The user's NFC ID is received by the NFC reader of the display. Optionally, the NFC reader of the display can send an acknowledgment to the user's NFC-enabled device. A shopper ID message is then communicated to media decision engine/module 121 which can reside at the set-top box 120, or a local or remote server such as the server 110 of the content distribution system 100 of FIG. 1 or the NMC 210 or NOC 220 of the in-store advertising network 200 of FIG. 2. At the media decision engine/module an action is taken depending on the received user identification. For example in one embodiment and as depicted in FIG. 3, a local over-ride command can be communicated to a playback control device to, for example, display an alternate piece of content then what was scheduled to play, upon the identification of the user as described above. The selected content is then displayed on the display.

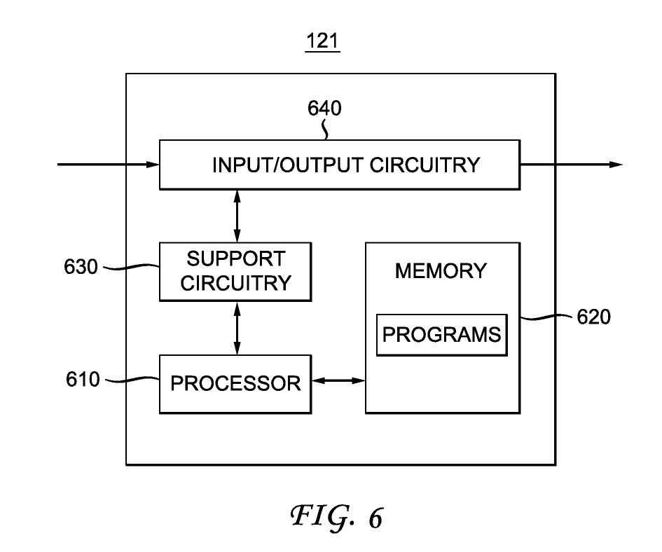

FIG. 6 depicts a high-level block diagram of a media decision engine/module 121 in accordance with an embodiment of the present invention. More specifically, the media decision engine/module 121 of FIG. 6 illustratively comprises a processor 610 as well as a memory 620 for storing control programs, file information, stored media and the like. The processor 610 cooperates with conventional support circuitry 630 such as power supplies, clock circuits, cache memory and the like as well as circuits that assist in executing the software routines stored in the memory 620. As such, it is contemplated that some of the process steps discussed herein as software processes may be implemented within hardware, for example, as circuitry that cooperates with the processor 610 to perform various steps. The media decision engine/module 121 also contains input-output circuitry 640 that forms an interface between various functional elements communicating with the media decision engine/module 121.

Again, although the media decision engine/module 121 of FIG. 6 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software executed by a processor, hardware, or a combination thereof. In addition, although the media decision engine/module 121 of FIG. 6 is depicted as a separate component, the functionalities of the media decision engine/module 121 in accordance with the concepts and embodiments of the present invention described herein can be incorporated into an existing content management system component such as a set-top box, personal video recorder, digital video recorder or content provider server and the like.

In an alternate embodiment of the present invention, a more complex interaction may result from the NFC-enabled interaction described above. An example of such a complex interaction might include the presentation on the mobile device of the user of further information regarding the product of interest or information regarding related products of interest. For example, if the product on the screen was a cleanser, the products displayed on the mobile device can include mops and buckets; or, if the product was a digital camera, the products on the mobile device can include memory cards and camera cases. The choice of related products can be based on data known as a result of the identification of the user.

For example, in one embodiment of the present invention, the presentation of related product information can be performed by the system sending a message over NFC-enabled communications back to the mobile device that results in launching a web browser pointed to product information, or it could launch a video explaining more about the product, or provide a digital coupon for the product. This could also be accomplished through integration with a mobile software application that presented information or managed that information for the user. One example of this is that the user may be interested in the product being displayed on the screen. Placing their mobile device near the NFC sensor could trigger an interaction where the product is added to a shopping list that the application maintains (or to a list that the application supports being maintained using an API). In such an embodiment, the product information can be communicated directly to the user's mobile device.

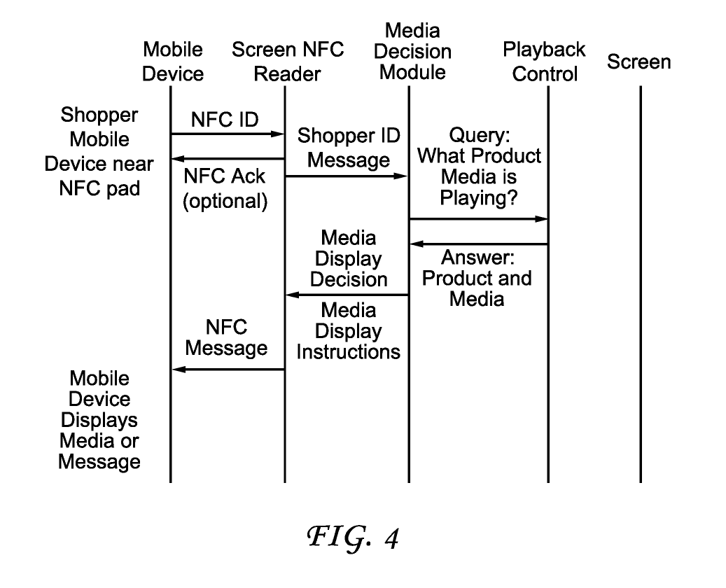

For example, FIG. 4 depicts a sequence diagram of the display of media related to a product display on a mobile device display in accordance with an alternate embodiment of the present invention. As depicted in FIG. 4, a user places an NFC-enabled device near the NFC pad of the display. The user's NFC ID is received by the NFC reader of the display. Optionally, the NFC reader of the display can send an acknowledgment to the user's NFC-enabled device. A shopper ID message is then communicated to a media decision engine/module. In the embodiment of FIG. 1, a query is then communicated to a playback control device (e.g., set-top box) to determine, for example, what product media is being played. The playback control device sends a message to the media decision engine/module identifying what product media is being played. The media decision engine/module then determines media content to be displayed on, for example, the user's mobile device and determines media display instructions which are communicated to the user's mobile device using the NFC-enabled communications. Alternatively, as described above, media content being presented on the display screen can be over-ridden with alternative content depending on an identified user/viewer.

In an alternate embodiment of the present invention, product information related to advertising content being displayed on an NFC-enabled display in accordance with the present invention can be used to send product information to a user's friends using social networking technologies.

In an alternate embodiment of the present invention, in an advertising environment in which a display at the entrance of a store is displaying a series of videos about products that are on sale that day, a user/shopper can place their NFC-enabled mobile device near the display's active NFC pad while a specific product media is being played resulting in the download of a coupon for that product. The system would record that interaction and know that the shopper had downloaded the coupon. This expression of interest in that product is recorded and saved for later use. One possible use for that interaction can be to remind the shopper that they did not redeem the coupon at a point of sale, such as at a time of checkout. Such an embodiment would use a screen or NFC reader at the checkout stand.

Another possible interaction might be that when the user/shopper places their device on the NFC pad that the system begins playing media aimed specifically at that shopper based on information known about them through other identification means, such as through a loyalty program for that shopper.

In an alternate embodiment of the present invention in a home network context, the NFC pad on the screen could support the ability for viewers to identify themselves to the home theater system. Several different data exchanges are then made possible. One example would be the download of the content and planned recording schedule of the digital video recorder (DVR) to the mobile device, allowing the user to then use the mobile device to control the system without needing to obtain that data over the local network.

In an alternate embodiment of the present invention, the identification of a user using NFC communication, as described above, can be utilized to configure the settings of a display, or associated playout device, in accordance with user preferences. For example, a DVR and/or media system is enabled to choose an identified user's preferences for setup and content availability. For example, one user may prefer certain brightness levels or audio settings, or prefer to have their recorded media placed at the top of menus for easier access. Another example would be to have the media system present only media of a certain rating based on the user identity: perhaps the system would only list media that was rated G, PG or PG-13 unless the identity was a parent. Such control systems could ‘forget’ their settings on power off or using other means to detect when the user has left the area, or perhaps a new button on a remote or a timeout.

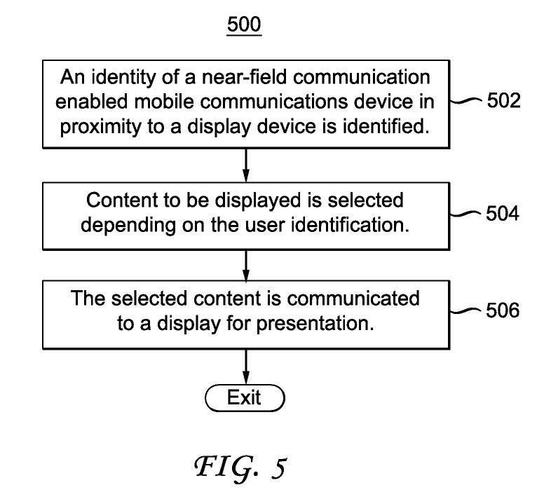

FIG. 5 depicts a flow diagram of a method for using near field communication for interacting with media on a display in accordance with an embodiment of the present invention. The method 500 of FIG. 5 begins at step 502 at which an NFC-enabled mobile communications device positioned proximate to an NFC-enabled display is identified, for example in one embodiment from the NFC id. The method 500 then proceeds to step 504.

At step 504, content to be displayed is selected depending on the user identification. For example and as described above, in one embodiment of the present invention, a local over-ride command is communicated to a playback control device to display an alternate piece of content then what was scheduled to play, upon the identification of the user. Alternatively and as described above, in an alternate embodiment of the present invention, further information regarding the product being advertised can be displayed or information regarding related products of interest can also be displayed in response to the identification of a particular user. The method 500 then proceeds to step 506.

At step 506, the selected content is communicated to a display for presentation. The method 500 can then be exited.

Having described various embodiments of a method, apparatus and system for interacting with media screens using near field communications (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for interacting with content on a display device, comprising:
determining an identity of a near-field communication enabled mobile communications device in proximity to said display device, said display device including near-field communication capabilities; and
selecting content to communicate to said display device based on the determined identity of said near-field communication enabled mobile communications device.

2. The method of claim 1, wherein the identity of the near-field communication enabled mobile communications device is determined using a near-field communication (NFC) ID of said mobile communications device.

3. The method of claim 1, wherein the identity of the near-field communication enabled mobile communications device is determined using identification information provided by a user of said mobile communications device.

4. The method of claim 1, wherein selecting content to communicate to said display device based on the determined identity of said near-field communication enabled mobile communications device comprises displaying an alternate segment of content then what was scheduled to be presented on said display device upon the identification of said mobile communications device.

5. The method of claim 4, wherein said alternate segment of content comprises advertising media directed to advertising a product of interest to an identified user of said mobile communications device.

6. The method of claim 1, wherein selecting content to communicate to said display device based on the determined identity of said near-field communication enabled mobile communications device comprises displaying advertising media directed to products related to a product being advertised on the display device at the time when the identity of the mobile communications device was determined.

7. The method of claim 1 wherein the selected content is communicated to the mobile communications device.

8. The method of claim 7, wherein said selected content is intended to be displayed on a display of the mobile communications device.

9. The method of claim 7, wherein said selected content comprises a list of products to which a user of the mobile communications device has been exposed.

10. The method of claim 1, wherein the selected content comprises an internet address directing a user to a web page which contains information regarding a product being displayed on the display device at the time when the identity of the mobile communications device was determined.

11. The method of claim 1, wherein the selected content comprises a coupon for a product presented on the display.

12. The method of claim 11, further comprising communicating at a point of sale, to the mobile communications device, an identification of each product for which the mobile communications device received a coupon.

13. The method of claim 1, wherein the selected content comprises configuration parameters for at least one of the display or a content playout device.

14. An apparatus for enabling interaction with content on a display device comprising:
a memory for storing program routines and data; and
a processor for executing said program routines, said processor, when executing said program routines, configured to perform the steps of:
determining an identity of a near-field communication enabled mobile communications device in proximity to said display device, said display device including near-field communication capabilities; and
selecting content to communicate to said display device based on the determined identity of said near-field communication enabled mobile communications device.

15. The apparatus of claim 15, wherein said processor comprises a media decision engine.

16. A system for enabling interaction with content on a display device, comprising:
at least one content source for providing media content;
an apparatus including a memory for storing program routines and data, and a processor for executing said program routines, said processor, when executing said program routines, configured to perform the steps of:
determining an identity of a near-field communication enabled mobile communications device in proximity to said display device, said display device including near-field communication capabilities; and
selecting content to communicate to said display device based on the determined identity of said near-field communication enabled mobile communications device; and
a display for displaying at least one of the selected content and data related to the selected content.

17. The system of claim 16, wherein said at least one content source comprises at least one of an advertiser, a recording company and a movie studio.

18. The system of claim 16, wherein said apparatus comprises a server of at least one of a network management center, a network operations center and a content distribution network.
